(19) United States
(12) Patent Application Publication
(10) Pub. No.: US 2024/0119855 A1
(43) Pub. Date: Apr. 11, 2024

(54) COMPUTERIZED PARTIAL GRADING SYSTEM AND METHOD

(71) Applicant: North Carolina State University, Raleigh, NC (US)

(72) Inventors: Cesar Delgado, Cary, NC (US); Thomas Kenan Miller, III, Raleigh, NC (US)

(21) Appl. No.: 18/275,712

(22) PCT Filed: Feb. 4, 2022
(86) PCT No.: PCT/US2022/015270

§ 371 Date: Aug. 3, 2023

Related U.S. Application Data
(60) Provisional application No. 63/145,511, filed on Feb. 4, 2021.

(51) Int. Cl. G09B 7/02

(52) U.S. Cl. CPC G09B 7/02

(57) ABSTRACT

An exemplary testing system and method are disclosed to provide (i) computerized testing of unstructured questions such as quantitative constructed-response problems (QCRP) configured as words problems and (ii) a corresponding grading engine and computerized grading platform to determine partial or full credit or score for the problem.

### RELATED APPLICATION

This PCT application claims priority to, and the benefit of, U.S. Provisional Patent Application No. 63/145,511, filed Feb. 4, 2021, entitled “Automated Partial Grading System and Method,” which is incorporated by reference herein in its entirety.

### BACKGROUND

Quantitative constructed-response problems (QCRPs) such as word problems are extensively assigned to students in the STEM curriculum, in finance, and other fields, in the form of homework, classwork, course exams, and standardized exams. QCRP tests are widely used and can provide more information about what the student knows than multiple-choice problems, as both the problem-solving procedure and the answer can be evaluated. Quantitative constructed-response problems are inherently unstructured in their formulation and yield unstructured answers.

There is a benefit in having a test system that can automatically determine scoring for quantitative constructed-response problems and the like.

### SUMMARY

An exemplary testing system and method are disclosed comprising unstructured questions (such as quantitative constructed-response problems QCRP) and a grading engine to determine partial or full credit or score for the correctness of the provided answer. The test system provides a graphical user interface that is configured to receive inputs from a taker/user to solve a problem. The interface provides a problem statement and auxiliary resources in the form of equations or data, or periodic tables, as well as mathematical operators, and is configured to follow a test taker who can exclusively select and drag-and-drop elements from the problem statement, data tables, and provided mathematical operators that mimic free-entry answer. The drag-and-dropped elements generate a response model that can be evaluated against an answer model. The exemplary system and method constrain the answers that can be provided to the unstructured question, to which a manageable number of answer rules may be applied while providing for a test or evaluation that are comparable to existing advanced placement examination and standardized test.

The framework reduces the large combinations of potential values, pathways, and errors without constraining solution pathways. Different pathways leading to the unique correct answer can lead to the same ultimate combination of values from problem statements, tables, and mathematical operators. The ultimate combination is assessed by a grading engine (also referred to as “grader”), implementing a grading algorithm, with points awarded for components corresponding to solution steps. Grade-It allows for fine-grained, weighted scoring of QCRPs. Grade-It's overall impact on STEM education could be transformative, leading to a focus on problem-solving rather than answer identification and guessing as multiple-choice tests can encourage.

In some embodiments, the grading engine is configured with a solver that can generate intermediate outputs for the provided answer. The grading engine is configured to transform a provided answer to a single rubric answer to which a grading solver can be applied. The exemplary testing system includes a test development environment to set up the test question. The test development environment includes a rubric development interface that can accept one or more answer solution approaches. The test development environment includes a solver that can provide intermediate outputs for a given answer solution approach.

In some embodiments, the exemplary system is used to grade courses, homework sets, and exams in STEM, finance, and other fields that apply mathematics by taking electronic or paper-based exams and generating a scored exam for them. In some embodiments, the determined scores are generated and presented on the same exam. In other embodiments, the determined scores are generated and presented in a report. In other embodiments, the determined scores are generated and stored in a database from which a report may be generated.

In some embodiments, the exemplary system is used to grade standardized exams like AP and IB tests that conventionally use human scorers to grade QCRPs.

In some embodiments, the exemplary system is used to provide personalized learning environments to students in secondary and tertiary education.

In some embodiments, the exemplary system is used for problem-solving problems in a workplace setting, e.g., for training and/or compliance evaluation.

In an aspect, a computer-implemented method is disclosed comprising providing, by a processor, via a graphical user interface (GUI), in an assessment screen of the GUI, a word problem comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question; in response to receiving via the GUI a set of inputs from the assessment screen, wherein each of the set of inputs includes a selectable displayed element from the set of selectable displayed elements, placing, by the processor, the selectable displayed element in one or more scorable response models; matching, by the processor, the one or more scorable response models to a set of one or more rubric response models, wherein each of the one or more rubric response models has an associated credit or score value; assigning, by the processor, a credit or score value associated with the one or more scorable response models based on the matching; and outputting, via the processor, via the graphical user interface, report, or database, the credit or score value for the word problem.

In some embodiments, the method further includes generating, by the processor, a consolidated scorable response model from the one or more scorable response models; performing an algebraic comparison of the set of one or more rubric response models and the consolidated scorable response models to identify a presence of at least one of the set of one or more rubric response models; and assigning, by the processor, a partial credit or score value associated with at least one of the set of one or more rubric response models.

In some embodiments, the method further includes determining, by the processor, a total partial credit or score value for the word problem by summing each matching set of one or more rubric response models to the consolidated scorable response model.

In some embodiments, the method further includes matching, by the processor, the one or more scorable response models to a second set of one or more rubric response models, wherein each of the second set of one or more rubric response models has an associated credit or score value, and wherein at least one of the rubric response models of the second set of one or more rubric response models is different from the set of one or more rubric response models.

In some embodiments, the method further includes determining a highest aggregated score among the set of one or more rubric response models and the second set of one or more rubric response models, wherein the highest aggregated score is assigned as the score for the word problem.

In some embodiments, the algebraic comparison is performed by a solver configured to perform symbolic manipulations on algebraic objects.

In some embodiments, the method further includes receiving input from a second assessment screen, wherein the second assessment screen comprises a plurality of constant values organized and arranged as at least one of a constant table and a Periodic table.

In some embodiments, the GUI includes a plurality of input fields to receive the one or more scorable response models, wherein each input field is configured to receive a scorable response model of the one or more scorable response models to provide a constructed response for the word problem.

In some embodiments, the word problem has an associated subject matter of at least one of a math problem, a chemistry problem, a physics problem, a business school problem, a science, technology, and math (STEM) problem, and an engineering problem.

In some embodiments, the one or more rubric response models and the associated credit or score values are generated in a test development workspace.

In some embodiments, the test development workspace includes a plurality of input rubric fields to receive the one or more rubric response models and the associated credit or score values.

In another aspect, a method is disclosed to administer a computerized word problem, the method comprising providing, by a processor, via a graphical user interface (GUI), in an assessment screen of the GUI, a word problem comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question; receiving, by a processor, one or more scorable response models from a computerized testing workspace, including a first scorable response model comprising a set of selectable displayed elements selected from the computerized testing workspace from a word problem comprising (i) a set of fixed displayed elements having at least one of text, symbol, and equations and (ii) a set of selectable displayed elements having at least one of text, symbol, and equations interspersed within the set of fixed displayed elements, wherein the one or more scorable response models are matched by a grading algorithm to a set of one or more rubric response models, wherein each of the one or more rubric response models has an associated credit or score value, and wherein the credit or score values associated with each match scorable response model is aggregated to determine a score for the word problem.

In another aspect, a system is disclosed comprising a processor; and a memory having instructions stored thereon, wherein execution of the instructions by the processor causes the processor to provide, via a graphical user interface (GUI), in an assessment screen of the GUI, a word problem comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question; in response to receiving via the GUI a set of inputs from the assessment screen, wherein each of the set of inputs includes a selectable displayed element from the set of selectable displayed elements, place the selectable displayed element in one or more scorable response models; match the one or more scorable response models to a set of one or more rubric response models, wherein each of the one or more rubric response models has an associated credit or score value; assign a credit or score value associated with the one or more scorable response models based on the matching; and output via the graphical user interface, report, or database, the credit or score value for the word problem.

In some embodiments, the execution of the instructions by the processor further causes the processor to generate a consolidated scorable response model from the one or more scorable response models; perform an algebraic comparison of the set of one or more rubric response models and the consolidated scorable response models to identify a presence of at least one of the set of one or more rubric response models; and assign a partial credit or score value associated with the at least one of the set of one or more rubric response models.

In some embodiments, the execution of the instructions by the processor further causes the processor to determine a total partial credit or score value for the word problem by summing each matching set of one or more rubric response models to the consolidated scorable response model.

In some embodiments, the execution of the instructions by the processor further causes the processor to match the one or more scorable response models to a second set of one or more rubric response models, wherein each of the second set of one or more rubric response models has an associated credit or score value, and wherein at least one of the rubric response models of the second set of one or more rubric response models is different from the set of one or more rubric response models.

In some embodiments, the execution of the instructions by the processor further causes the processor to determine a highest aggregated score among the set of one or more rubric response models and the second set of one or more rubric response models, wherein the highest aggregated score is assigned as the score for the word problem.

In some embodiments, the algebraic comparison is performed by a solver configured to perform symbolic manipulations on algebraic objects.

In some embodiments, the execution of the instructions by the processor further causes the processor to receive input from a second assessment screen, wherein the second assessment screen comprises a plurality of constant values organized and arranged as at least one of a constant table and a Periodic table.

In some embodiments, the GUI includes a plurality of input fields to receive the one or more scorable response models, wherein each input field is configured to receive a scorable response model of the one or more scorable response models to provide a constructed response for the word problem.

In some embodiments, the one or more rubric response models and the associated credit or score values are generated in a test development workspace.

In some embodiments, the system further includes the test development workspace, the test development workspace being configured to present a plurality of input rubric fields to receive the one or more rubric response models and the associated credit or score values.

In some embodiments, the system further includes a data store configured to store a library of template or example word problems and associated rubric solutions.

In another aspect, a non-transitory computer-readable medium is disclosed having instruction stored thereon wherein execution of the instructions by a processor causes the processor to provide, via a graphical user interface (GUI), in an assessment screen of the GUI, a word problem comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question; in response to receiving via the GUI a set of inputs from the assessment screen, wherein each of the set of inputs includes a selectable displayed element from the set of selectable displayed elements, place the selectable displayed element in one or more scorable response models; match the one or more scorable response models to a set of one or more rubric response models, wherein each of the one or more rubric response models has an associated credit or score value; assign a credit or score value associated with the one or more scorable response models based on the matching; and output via the graphical user interface, report, or database, the credit or score value for the word problem.

In some embodiments, the execution of the instructions by the processor further causes the processor to generate a consolidated scorable response model from the one or more scorable response models; perform an algebraic comparison of the set of one or more rubric response models and the consolidated scorable response models to identify a presence of at least one of the set of one or more rubric response models; and assign a partial credit or score value associated with the at least one of the set of one or more rubric response models.

In some embodiments, the execution of the instructions by the processor further causes the processor to determine a total partial credit or score value for the word problem by summing each matching set of one or more rubric response models to the consolidated scorable response model.

In some embodiments, the execution of the instructions by the processor further causes the processor to match the one or more scorable response models to a second set of one or more rubric response models, wherein each of the second set of one or more rubric response models has an associated credit or score value, and wherein at least one of the rubric response models of the second set of one or more rubric response models is different from the set of one or more rubric response models.

In some embodiments, the execution of the instructions by the processor further causes the processor to determine a highest aggregated score among the set of one or more rubric response models and the second set of one or more rubric response models, wherein the highest aggregated score is assigned as the score for the word problem.

In some embodiments, the algebraic comparison is performed by a solver configured to perform symbolic manipulations on algebraic objects.

In some embodiments, the execution of the instructions by the processor further causes the processor to receive input from a second assessment screen, wherein the second assessment screen comprises a plurality of constant values organized and arranged as at least one of a constant table and a Periodic table.

In some embodiments, the GUI includes a plurality of input fields to receive the one or more scorable response models, wherein each input field is configured to receive a scorable response model of the one or more scorable response models to provide a constructed response for the word problem.

In some embodiments, the one or more rubric response models and the associated credit or score values are generated in a test development workspace.

In another aspect, a system is disclosed comprising a processor; and a memory having instructions stored thereon, wherein the execution of the instructions by the processor causes the processor to perform any of the above-discussed methods.

In another aspect, a non-transitory computer-readable medium is disclosed having instruction stored thereon wherein execution of the instructions by a processor causes the processor to any of the above-discussed methods

### BRIEF DESCRIPTION OF DRAWINGS

Embodiments of the present invention may be better understood from the following detailed description when read in conjunction with the accompanying drawings. Such embodiments, which are for illustrative purposes only, depict novel and non-obvious aspects of the invention. The drawings include the following figures:

FIG. 1 shows an example computerized test system configured to provide open-ended unstructured-text test questions and perform automated partial or full grading in accordance with an illustrative embodiment.

FIG. 2A shows an example computerized test environment and interface, e.g., provided through the testing workflow module of FIG. 1, in accordance with an illustrative embodiment.

FIG. 2B shows an example answer model for a computerized word problem of FIG. 2A in accordance with an illustrative embodiment.

FIGS. 2C and 2D each show a method for scoring the answer model of FIGS. 2A and 2B in accordance with an illustrative embodiment.

FIG. 3A shows an example computerized test development environment and interface, system, e.g., provided through the test development environment platform of FIG. 1, in accordance with an illustrative embodiment.

FIGS. 3B-3H show aspects of an example implementation of the computerized test development environment and interface system of FIG. 3A, in accordance with an illustrative embodiment.

FIGS. 4A-4C show aspects of an example method to perform a computerized grading of a word problem in accordance with an illustrative embodiment.

FIG. 5 shows an example operation performed by the grading pipeline and algorithm of FIG. 1 in accordance with an illustrative embodiment.

FIG. 6 shows an example computing device that can implement the exemplary grading system in accordance with an illustrative embodiment.

### DETAILED SPECIFICATION

Each and every feature described herein, and each and every combination of two or more of such features, is included within the scope of the present invention provided that the features included in such a combination are not mutually inconsistent.

Example System

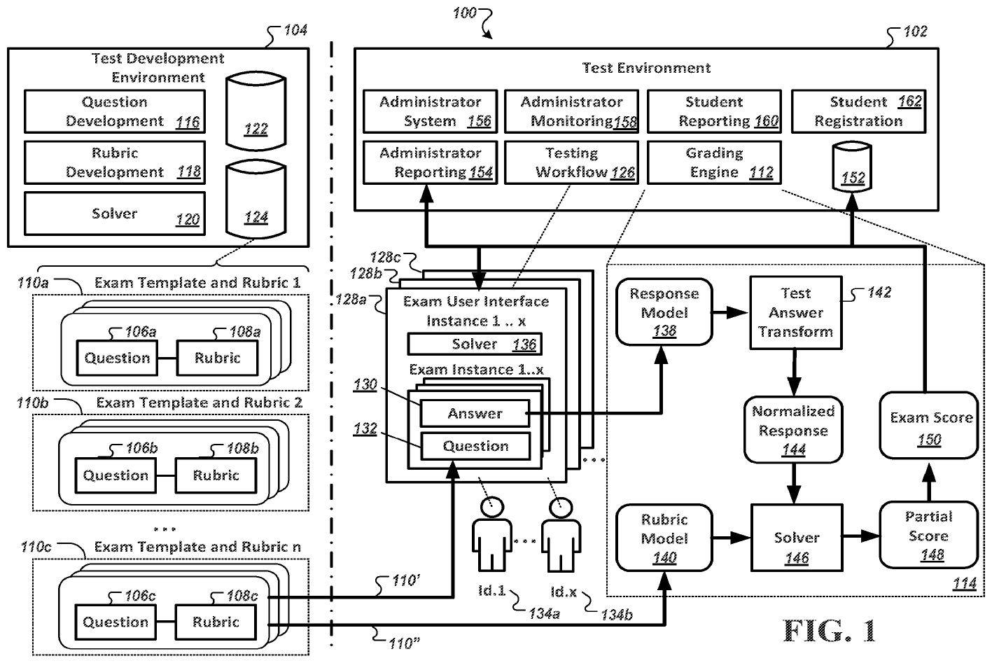

FIG. 1 shows an example computerized test system 100 configured to provide open-ended unstructured-text test questions and perform automated partial or full grading in accordance with an illustrative embodiment. The open-ended unstructured-text test questions (also referred to herein as “word problems”) can include “mathematical constructed-response problems” (also referred to herein as “math word problems”) as well as science, physics, chemistry word problems. The grading algorithm is configured to grade the test questions, which could be both open-ended and have multiple solution approaches. The test can include open-ended unstructured-text test questions in combination with selectable test questions such as multiple-choice questions or matching choice questions.

In the example shown in FIG. 1, system 100 includes a test environment platform 102 and a test development environment platform 104. The test environment platform 102 and test development environment platform 104 may be implemented as a cloud-based platform. In other embodiments, the test environment platform 102 and test development environment platform 104 can be implemented as a locally-executable software configured to run on a server or a machine, which may operate in conjunction with a cloud-based platform (e.g., for storage).

The test development environment platform 104 includes a set of modules or components, later described herein, that provides an interface for an exam developer/teacher to develop questions 106 (shown as 106a, 106b, 106c) and answer rubrics 108 (shown as 108a, 108b, 108c) for tests 110 (shown as “Exam Template and Rubric 1” 110a, “Exam Template and Rubric 2” 110b, and “Exam Template and Rubric n” 110c) comprising the open-ended unstructured-text question 106. The test environment platform 102 includes a set of modules or components, also later described herein, that provide an interface to administer a test 110 developed from the test development environment platform 104 and provide other administrative operations, including computerized grading, as described herein. Notably, the test environment platform 102 includes a grading engine 112 (also referred to as an “analysis system”) configured to execute a grading pipeline and algorithm 114 and a scoring workflow to provide computerized/algorithmic-based partial credit scoring, e.g., for mathematical constructed-response problems, other STEM response problems, and other word problems described herein. The tests 110 include open-ended unstructured-text questions 106, e.g., for topics in math, science, physics, chemistry, STEM, etc. The open-ended unstructured-text questions 106 can include secondary school questions, high school questions, entrance and standardized exam questions, college course questions (engineering, science, calculus, psychology, humanities), and professional exams (medical training). Unstructured-text questions may also include quantitative constructed-response problems and other unstructured questions, problems, game rules that can be used in an educational or game setting to evaluate a user/test taker's understanding of underlying knowledge. Indeed, the unstructured-text question may be configured as a school test or quiz, as questions in standardized tests, or level of an educational game.

The test development environment platform 104 includes a question development module 116, a rubric development module 118, a mathematical solver 120 (shown as “solver” 120), and a set of data stores including a template data store 122 and a test data store 124. The question development module 116 and rubric development module 118, in some embodiments, are configured to provide a computing environment that provides a graphical user interface to receive inputs from an exam developer/teacher to generate test questions, structure an exam, and create rubric answers for the generated test questions. The template data store 122 provides example word problems and solutions (e.g., rubrics) that can be selected to instantiate a given test by the exam developer/teacher to administer the test to a test taker/student, e.g., through the test development environment platform 104. The problems may be organized by topics and can be searchable based on a string-search of contents of the questions, titles of the examination, and labels associated with the test. The interface can be implemented in any programming language such as C/C++/C#, Java, Python, Perl, etc. Test data store 124 can store a programmed test template and/or rubric 110. In the example shown in FIG. 1, a test 110 as an example template and rubric can be searched or retrieved by the test environment platform 102. The test data store 124 may include permissions to provide access to a user based on the user log-in data. System 100 may maintain a library of open-ended unstructured-text question 106 and corresponding answer model 112 that can access and modified to generate new full tests, test templates, and new test library files. In some embodiments, system 100 may employ the open-ended unstructured-text question 106 with other test question formats, such as multiple-choice questions. System 100 may provide the open-ended unstructured-text question 106 in a pre-defined sequence. In other embodiments, the system 100 may shuffle the sequence of the open-ended unstructured-text question 106 based on the current scores. In some embodiments, the system 100 may employ the open-ended unstructured-text question 106 in combination, in the test, with open-ended questions (e.g., essay) to be evaluated manually by a person tasked with grading. In some embodiments, the system 100 may employ the open-ended unstructured-text question 106 to be evaluated manually by a person tasked with grading.

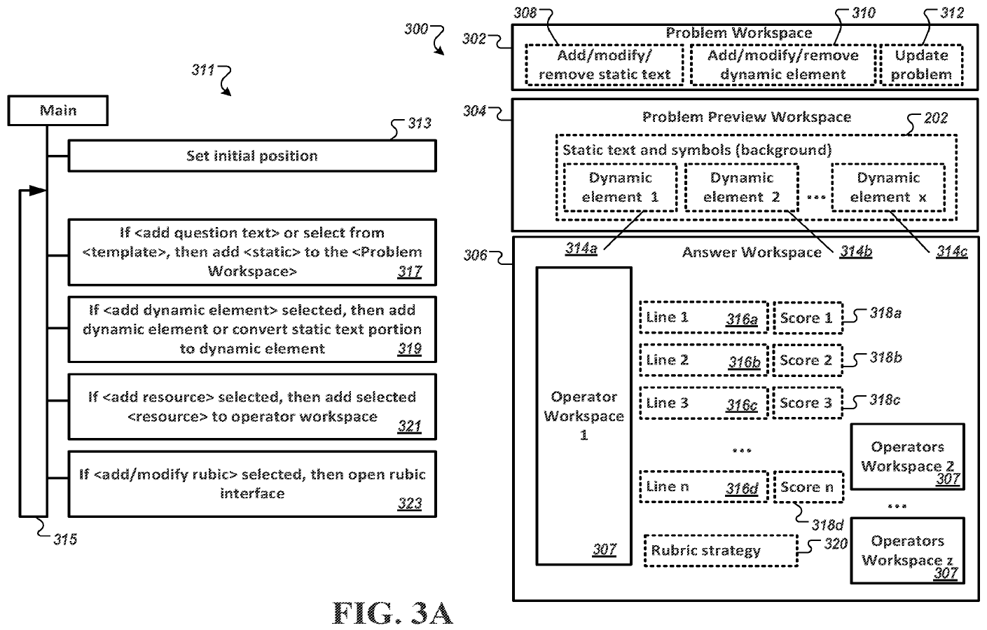

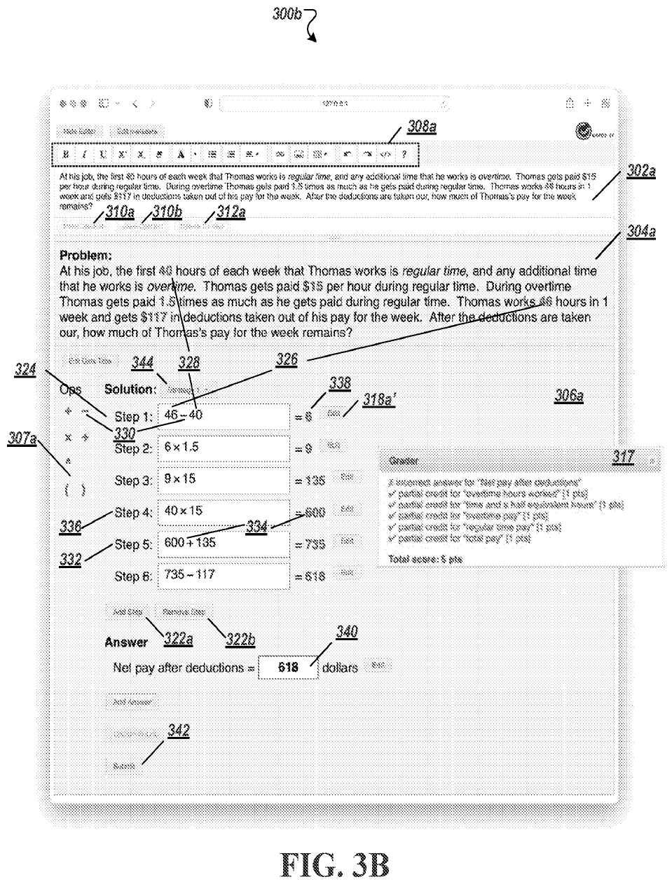

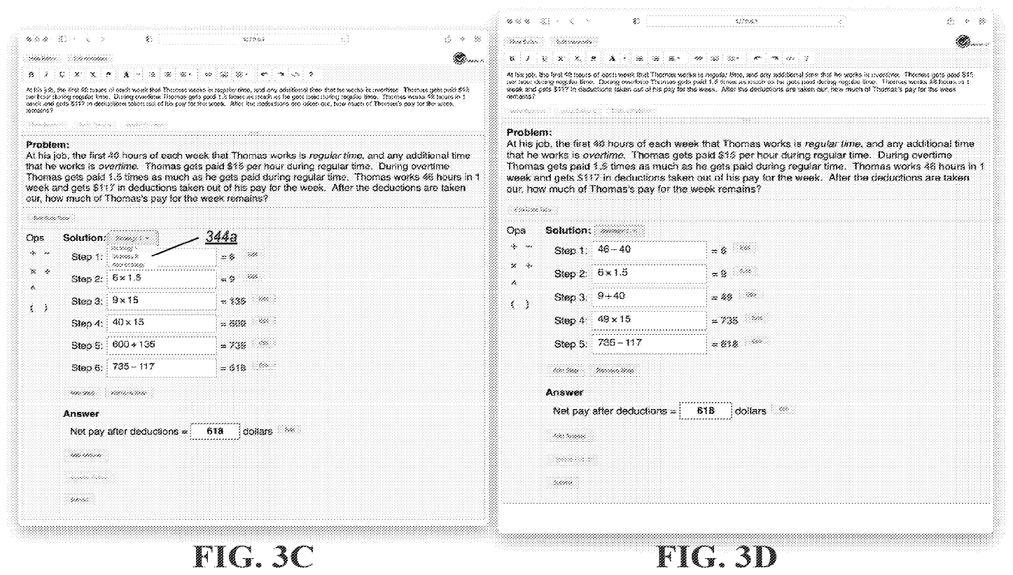

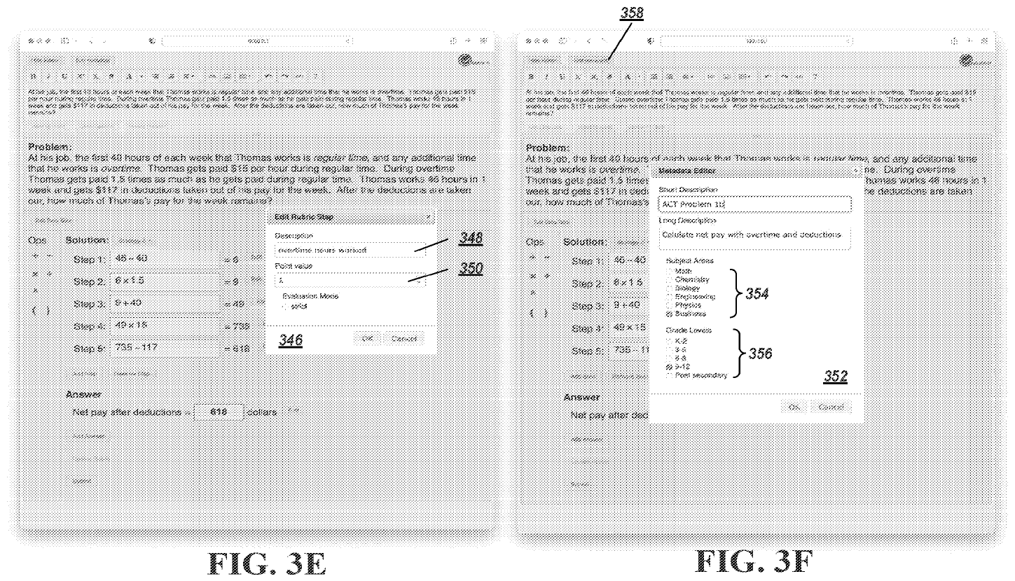

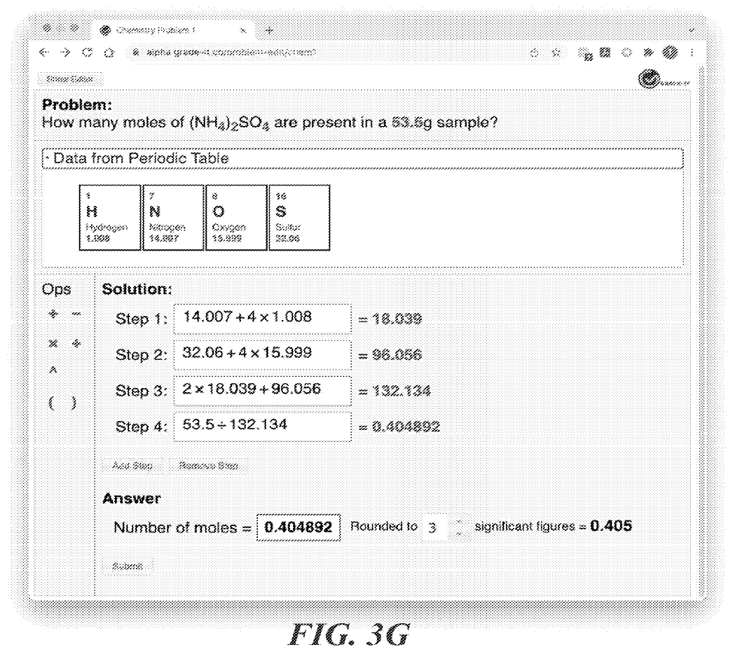

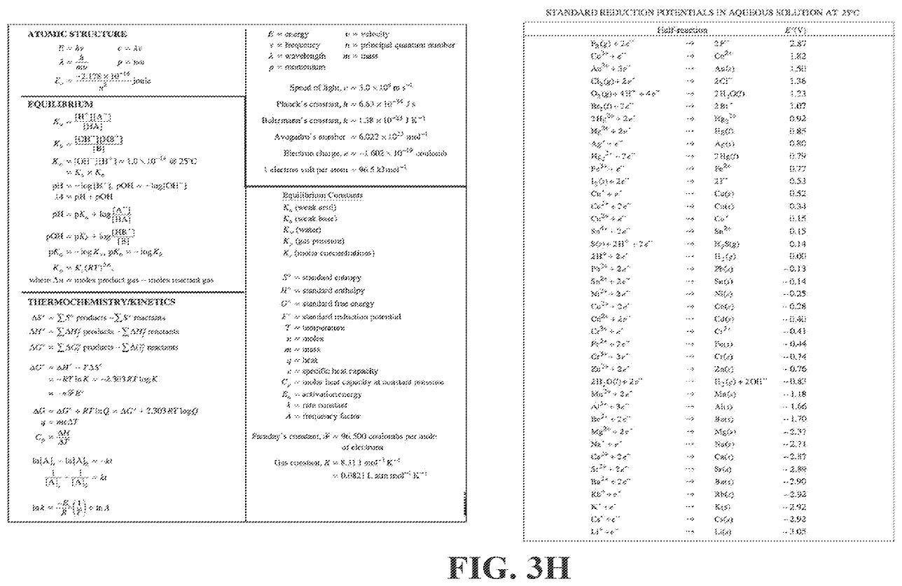

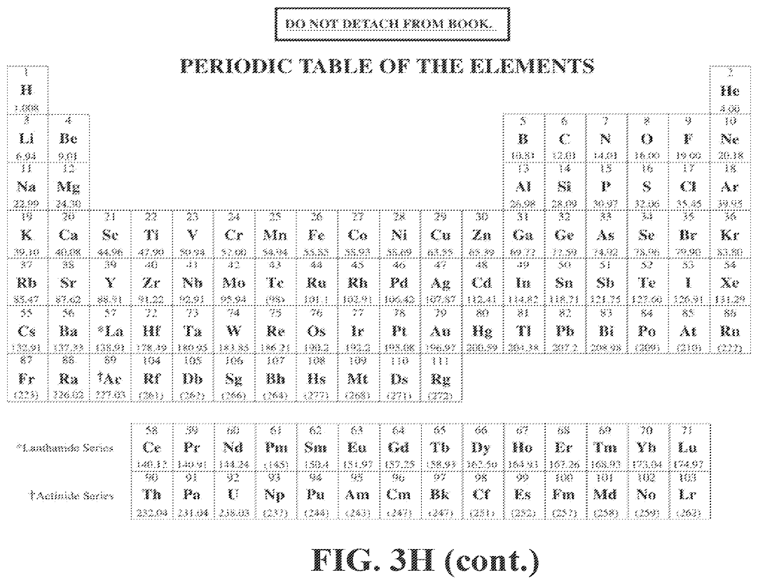

The test environment platform 102 includes a testing workflow module 126 configured to generate a workspace for a plurality of exam instances 128 (e.g., 128a, 128b, 128c) of a selected template and rubric 110 (shown as 110′). Each instantiated template and rubric (e.g., 128a, 128b, 128c) can include an instantiated answer model 130 and a question model 132 for each exam taker/student 134 (shown as “Id.1” 134a to “Id.x” 134b). The instantiated template and rubric (e.g., 128a, 128b, 128c) may include a solver or a solver instance 136 to perform an intermediate mathematical operation (e.g., addition, subtraction, multiplication, division, exponential, log, as well as vector operators, e.g., vector multiplication, vector addition, etc.) used by the exam taker/student in the exam. In some embodiments, the solver or solver instance is a calculator application. In some embodiments, the instantiated template and rubric (e.g., 128a, 128b, 128c) does not include a solver. FIGS. 3A-3F, to be later discussed, shows an example workspace for the question development module 116 and the rubric development module 118.

As discussed above, the test environment platform 102 includes the grading engine 112 configured to execute the grading pipeline/workflow 114 and the scoring algorithm that implements an assessment methodology for computerized/algorithmic partial credit scoring. The grading engine 112 is configured to generate an instance of a grading workflow (e.g., 114) once a test has been completed. The completed answer model 130 is provided as a response model 138 to the grading pipeline/workflow 114. In workflow 114, the grading engine 112 can retrieve a rubric answer model 140 (shown as 110″) from the data store 124 for a given response 138. The grading engine 112 includes a test answer transform module 142 configured to express the answers, e.g., of math word problems, in the response model 138 as sub-expressions that can then be consolidated to form a single consolidated expression 144 (shown as “Normalized response” 144). The grading engine 112 includes a solver 140 that can determine the presence of sub-expressions in the single consolidated expression (be it the same sub-expression or different sub-expression to the response model) and assign a score for that sub-expression based on the provided rubric model 140. The grading engine 112 includes a partial score module 148 and exam score module 150 that can respectively determine the partial scores (as well as a full score if applicable) for a given problem and consolidate the problem score to determine a score for the exam. The grading engine 112 can store the exam score and/or individual partial scores to a test environment data store 152 as well as provide the exam score and/or individual partial scores to an administrator reporting module 154, e.g., to present the score to the test taker/student.

In the example shown in FIG. 1, the test environment platform 102 includes an administrator system module 156, an administrator monitoring module 158, a student reporting module 160, and a student registration module 162. The administrator system module 156 includes components manage administrator list and manage the various modules in the test environment platform 102. The administrator monitoring module 158 is configured to provide an interface to the status of a given exam that is in progress. The monitoring module 158 provides test-taking operations for the administrator, e.g., to freeze or unfreeze the remaining time for an exam, adjust the remaining time for a given exam or a specific student exam, view the current completed status of an exam or specific student exam, and view any metadata tracked by the testing workflow for a given exam. The student reporting module 160 is configured to generate a test report for a given student and exam. In some embodiments, the student reporting module 160 may include a web portal that allows for the report to be accessed electronically. The student registration module 162 is configured to allow registrations by test takers/students of an exam.

Example Computerized Test Environment and Interface

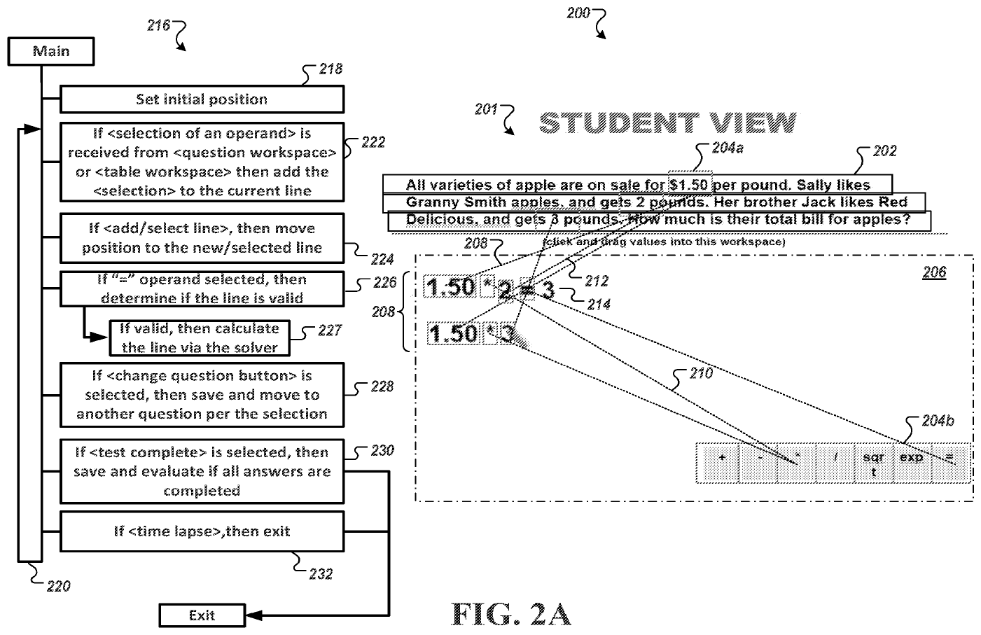

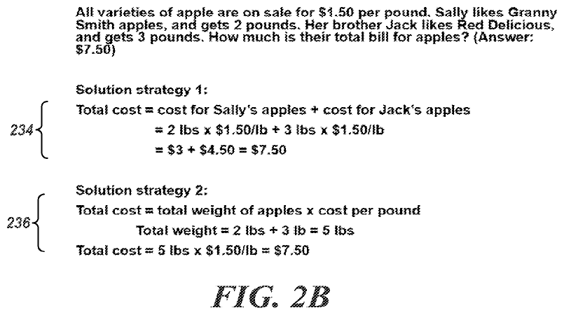

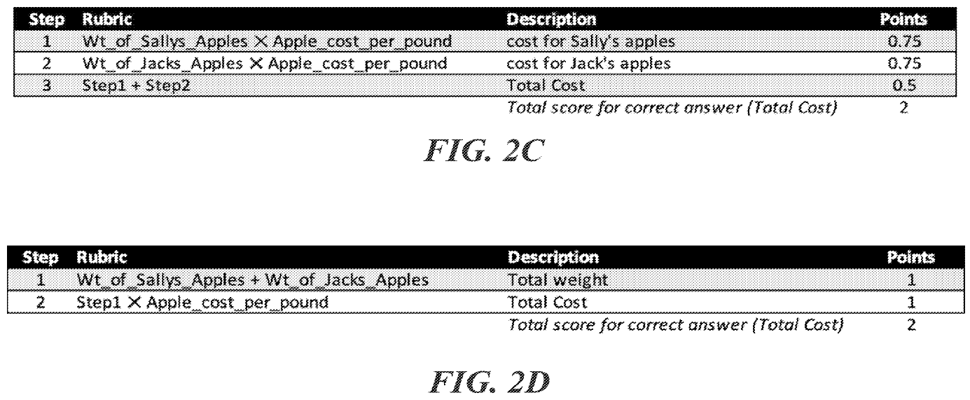

FIG. 2A shows an example computerized test environment and interface (shown as 200), e.g., provided through the testing workflow module 126 of FIG. 1, in accordance with an illustrative embodiment. The computerized test environment and interface 200 is configured to present text data 202 and selectable displayed elements 204 for an open-ended unstructured-text question (e.g., 106) (shown as 201), e.g., to a test taker/student, and receive input in a workspace 206. Workspace 206 can be entirely unconstrained with respect to the placement of the test taker's inputs, or workspace 206 can be constrained with respect to a line.

In the example shown in FIG. 2A, the computerized test environment and interface 200 is configured to display text for an open-ended unstructured-text question (e.g., 106), e.g., for a math word problem. As noted, the open-ended unstructured-text question (e.g., 106) includes a set of fixed displayed elements 202 (e.g., equations, numbers, variables, symbols, or text) and a set of selectable displayed elements 204a (e.g., equations, numbers, variables, symbols, or text) (also referred to as “operand”) interspersed within the set of fixed displayed elements 202 to collectively form the open-ended unstructured-text question 106. The question (e.g., 106) also includes a second set of selectable displayed elements 204b that are a part of a set of operators (shown as “+,” “−,” “*,” “/,” “sqrt,” “exp,” and “=”). Other operators, e.g., those described herein, can be employed.

Each input is selectable from the selectable displayed elements 204 (shown as 204a) in the open-ended unstructured-text question platform 104 or operator section 204b by a user selection (e.g., mouse click) or by a drag-and-drop operation. Each of the inputs places the selected displayed element into the scorable response model (shown as “response model” 208), e.g., at an indexable position. In other embodiments, the selected displayed element is added to an expression that forms a sub-expression for the answer. The sub-expression of the provided can be combined to form a single expression to which a different sub-expression provided by the rubric can be applied. From either embodiment, the user (e.g., test taker/student) can thus construct an answer model (e.g., 138) by selecting elements from the selectable displayed elements (e.g., 204a, 204b) in the open-ended unstructured-text question 201. In doing so, the answer is constrained to a subset of solutions and in some implementations, as sub-expressions, that may be stored in an answer model 108 to which the response model 106 can be compared, or operated upon, by the system 100, e.g., the grading engine 112.

In the example shown in FIG. 2A, the word problem sets out operations to be performed by two entities, Sally and Jack. The word problem requires the test taker to determine algebraic solutions for each of the two entities and then sum the two sub-solutions together for the final solution. Of course, the final solution can be calculated through a single expression.

To generate an answer model, in response to receiving via the graphical user interface a first input (208) comprising a first selected answer element (also referred to herein as “operand”) from the assessment screen, the system places the first selectable displayed element (208) in a first response position of a first scorable response model of the one or more scorable response models. The first response position is located at a first indexable position, or sub-expression, of the first scorable response model. In response to receiving via the graphical user interface a second input (210) (e.g., a symbol, such as addition or subtraction operator) from the assessment screen, the system places the second selectable displayed element in a second response position, or the same sub-expression as the first selectable displayed element, of the first scorable response model, wherein the second response position is located proximal to the first response position. In response to receiving via the graphical user interface a third input (212) (e.g., a symbol, such as addition or subtraction operator) from the assessment screen, the system places the third selectable displayed element in a third response position or the same sub-expression as the first and second selectable displayed element, of the first scorable response model. The third response position is located proximal to the first response position. The process is repeated until the entire response model is generated by the test taker/student.

In some embodiments, the computerized test environment and interface 200 is configured with a solver that can be invoked when certain selected answer elements, e.g., “=” (equal operator), are added to the workspace 206. Specifically, the solver (e.g., 136), when invoked, can calculate a result of the generated sub-expression or first scorable response model to return a solution (214) that is then added to the workspace 206. In other embodiments, the computerized test environment and interface 200 may provide either (i) a command for the user/test taker to provide an answer for the generated sub-expression or each scorable response model or (ii) command for a calculator application to be invoked to which the solution can be calculated and directed to be inserted into the problem.

In some embodiments, to capture the intent of the user/test taker in providing an additional response model, the system may include an input widget (e.g., button) that allows the user/test taker to move between the response models (i.e., move between different lines of the provided answer) or to add other response models (e.g., add new lines). In other embodiments, the system is configured to determine when the user/test taker drags and drops a selectable element in a new line.

The system 100, e.g., grading engine 112, can determine a correct response for each response model 106 where each response model can provide a score (shown as “partial score” 110) as a partial credit or score for a given question (e.g., 106). The system 100 can determine the partial score 110 for each question (e.g., 106) and combine the score to provide a total score for that open-ended unstructured-text question 106. System 100, e.g., grading engine 112, may evaluate each open-ended unstructured-text question 106 to determine a score for a given test.

The system 100 can output the partial score (e.g., 148) for each response model, the aggregated score for a given question, or the total score for the test to a report or database. In some embodiments, the partial score (e.g., 148) for each response model, the aggregated score for a given question, or the total score may be presented to the test taker. In some embodiments, the partial score (e.g., 148) for each response model, the aggregated score for a given question, or the total score may be presented to the test taker where the test is a mock test or in a training module. In some embodiments, the partial score (e.g., 148) for each response model, the aggregated score for a given question, or the total score may be stored in a report or database. The report or database may be a score for an official record or maybe scores for the mock test or in a training module.

FIG. 2A also shows an example process 216 of the computerized test environment and interface 200. In the example, process 216 includes setting (218) an initial position of the current cursor input. Process 216 may then execute a loop (220), e.g., for the testing workflow module 126 of FIG. 1, to monitor for specific events, including detection of a selection of an operand (222), detection of an add-line or select line command (224), detection of an “=” operand being selected (226), which may invoke a sub-function (227) involving the solver (e.g., 136), detection of an administrative test function to move to a different question (228), detection of an administrative test function to complete the exam (230), or detection of a time complete criteria to complete the exam (232).

Other Examples Open-Ended Unstructured-Text Question

FIG. 2B shows an example answer model. In FIG. 2B, the answer model is shown in a readable form in relation to an open-ended unstructured-text question. As shown in FIG. 2B, the system can provide two sets of answer models for the question, shown as 234, 236.

A similar answer and question construction may be created for any constructed response problem, math problems, chemistry problems, physics problems, finance problems, among others described herein. Though shown as symbols and numbers in FIG. 2B, the answer may be an equation, a variable, a symbol, or text. FIGS. 2C and 2D show two methods for scoring the answer model of FIGS. 2A and 2B, e.g., by weighted grading or by fine-grained grading. The scoring may be based on integer, fraction, or any value expression. The partial credit for a solution step could be a fraction of the total score for a correct answer. For example, a four step problem could assign a total value for a correct score as 3 points, and specify that each partial credit is 25% of the total, which would be 0.75 points for each partial credit step.

Example Computerized Test Development Environment and Interface

FIG. 3A shows an example computerized test development environment and interface 300, e.g., provided through the test development environment platform 104 of FIG. 1, in accordance with an illustrative embodiment. In the example of FIG. 3A, the computerized test environment and interface 300 is configured to present a first input pane 302, a second preview pane 304, an answer workspace 306, and zero or more operator and resource workspaces 307. The first input pane 302 provides an input workspace to receive static text input and dynamic elements that collectively form a word problem from the test developer. The second preview pane 304 is configured to take the user input provided into the input workspace (e.g., 302) to present the open-ended unstructured-text question (e.g., 106) to the test developer. The answer workspace 306 may correspond to the input workspace to be presented to the test taker/student to receive their inputs. In the computerized test development environment and interface 300, the answer workspace 306 may provide an input workspace to receive the answer rubrics for the word problem provided in the input workspace (e.g., 302) from the test developer.

The first input pane 302 may include a button 308 to add, modify, or remove the static text once initially provided. The first input pane 302 may include a second button 310 to add a dynamic element (also previously referred to as a “selectable displayed element” 204a or “operand”) to the input workspace or to modify a selected static text into a dynamic element. The first input pane 302 may include a third button 310 to accept edits made to the input workspace.

Dynamic element (e.g., operand) may be assigned a symbolic name, e.g., either through a dialogue box for adding a symbolic name or in a spatially assigned input pane as provided by the test development environment and interface 300, as the dynamic element is added to the problem workspace 302. In some embodiments, the dialogue box or input pane, in addition to having a field for the symbolic name, includes additional fields associated with the symbolic name, e.g., number of significant digits (e.g., number of significant decimal places) or data type (e.g., floating-point number, integer number, Boolean, angles (e.g., degree or rad), temperature (° F., ° C., ° K), etc.).

The second preview pane 304, as noted above, is configured to take the user input provided into the input workspace (e.g., 302) and present the open-ended unstructured-text question (e.g., 106) to the test developer. The open-ended unstructured-text question (e.g., 106) includes static text data objects (e.g., fixed displayed elements 202 of FIG. 2A) and selectable displayed elements (e.g., 204a) (shown as “Dynamic element 1” 314a, “Dynamic element 2” 314b, and “Dynamic element x” 314c).

The test development environment and interface 300 includes a standard operator workspace 307 that includes standard mathematical operators such as addition, subtraction, multiplication, division, exponentials, and parenthesis for order of operation. The operator and resource workspaces 307 may also include additional reference workspaces such as constant tables (e.g., physical constant, chemistry constant), equations, geometric identities and transforms, periodic tables, and other reference materials for a given testable subject matter. The second type of operator and resource workspace 307 provides “data tabs” or “data drawers” that are workspaces containing additional data relevant to the problem, such as elements of the Periodic Table, trig functions, or other relevant data tables, mathematical functions or operators as needed to solve the problem. These problem-specific workspaces may be shown or hidden by clicking on the “drawer.” By being able to toggle between their presentation and hidden mode, the workspace can be optimized for input from the test taker/student and provide a clutter-free interface.

FIG. 3A also shows an example process 311 of the computerized test environment and interface 300. In the example, process 311 includes setting (313) initial conditions for a newly instantiated test and test rubric. Process 311 may then execute a loop (315), e.g., for the question development module 116 and rubric development module 118 of FIG. 1, to monitor for specific events, including detection of the text editor operation (317), detection of an operand generation or modification (319), detection of operator workspace operation (321), detection of a rubric modification operation (323), among others.

FIG. 3B shows an example implementation of the computerized test development environment and interface 300 (shown as 300a). The interface 300a includes the input workspace 302 (shown as 302a), a set of buttons 310 (shown as 310a and 310b) to convert the static text in the workspace to an operand (i.e., dynamic element 314) and to unset the operand back to static text, and a button 312 (shown as 312a) to accept edits made to the workspace. The button 310a, in this example, upon being selected, results in a dialogue box being opened to accept a symbolic name for the operand (i.e., dynamic element 314). The operand (e.g., 314) can be colorized differently from the static text and/or have a different format style or size. As described herein, the operand (e.g., 314) includes a symbolic name and can have an associated constant value, equation/expression that can be manipulated to form a sub-expression for a constructed response. The workspace 302, in this example, includes a set of editor buttons 308 (shown as 308a) to add or modify static elements of the word problem, e.g., bold text, italicize text, underline text, add subscript, add superscript, change font color, justify text left/right/center, add bullets to text, add data object as an attachment to the workspace, add a picture to the workspace, add a table to the workspace. The editor buttons 308a also include a “</>” button to show the underlying executable code (e.g., HTML code) for the question as generated by the text editor. The executable code can be modified directly to add or remove HTML elements, e.g., change text format (bold, italic, etc.), adjust formatting, color, etc.

Referring to FIG. 3A, as noted above, the answer workspace 306 may include an input workspace to receive the answer rubrics for the word problem provided in the input workspace (e.g., 302) from the test developer to receive. The workspace may include multiple input fields 316 (shown as “Line 1” 316a, “Line 2” 316b, “Line 3” 316c, and “Line n” 316d) in which each input field (e.g., 316a-316d) has a corresponding input field 318 (shown as “Score 1” 318a, “Score 2” 318b, “Score 3” 318c, and “Score n” 318d) for an assignable credit or score value for a partial credit/scoring determination. These sub-expressions, as defined by the input fields 316, can be individually searched, via an algebraic comparison, to determine if credit/score can be assigned for a given constructed response provided by a test taker/student. The field may also provide an input for an explanation for the partial credit if desired. The answer workspace 306 may include a button 320 to select a different set of rubric answer strategies to which a different set of scoring/credit can be applied.

The inputs for each of the rubric may be selectable from operands (e.g., dynamic elements 204a) of the second preview pane 304 and the operand operators (e.g., dynamic elements 204b) of the operator workspace 307 (shown as 307a). The input fields 316 may present the values shown in the second preview workspace 304 or the symbolic names associated with those values. In some embodiments, the interface can show the values in the field and show the symbolic names when the cursor is hovering over that input field or vice versa. In some embodiments, the selection of the symbolic-name display or value display can be selectable via buttons located on the workspace 300 or in a preference window/tab (not shown).

In the example shown in FIG. 3B, an example rubric answer for a word problem example is shown. The rubric in this example shows 6 partial credit/scores that may be assigned for 6 different sub-expressions. The workspace 306a includes buttons 322 (shown as 322a, 322b) to add or remove lines 316. As shown in the example in FIG. 3B, the sub-expression of a given answer is shown by the values of the operand that are selected from the second preview pane 304a. For example, line “1” (shown as “Step 1” 324) includes two operands (shown as “46” 326 and “40” 328) and an operator operand (shown as subtraction symbol “-” 330). The first operand “46” (326) has a symbolic name of “worked_hours,” which is assignable and editable, and the second operand “40” (328) has a symbolic name of “base_line_hours,” also assignable and editable. The sub-expression generated in line “1” 324 per this example can be expressed as (work_hours−base_line_hours). In addition to the operand name, the interface 300 can assign each sub-expression 316 (e.g., 324)) a sub-expression name and may be assigned a value of “1” point, for example. Dialogue box 317 shows an example set of hypothetical partial score/credit values that may be assigned for the word problem of FIG. 3B, say, when the final solution is incorrect. The interface 300a includes an “edit” button 318 to open a dialogue box for each of the sub-expression, including an edit button (shown as 318a′) to edit the sub-expression name and associated score/credit for sub-expression “1” (324). The sub-expression can receive other sub-expressions as inputs as well. Sub-expression “5” (332) is shown to employ an operand 334 (shown having a value “600” 334) that is calculated from sub-expression “4” 336. To generate the value “600” for operand 334, the interface 300 may have incorporated a solver (e.g., solver 120 of FIG. 1) to generate a computed value 338 for each of the sub-expressions 316. The solver may be a mathematical solver that can perform at least the operators, e.g., of operator operand 307a. In other embodiments (not shown), interface 300 may present the sub-expression name and display the sub-expression name in the rubric answer.

The answer workspace 306 may include a final answer 340, which can be selected from any of the sub-expression computed values 338. Extra credit/score can be earned and assigned within this framework by having the final results selected at an intermediate (or non-final) sub-expression. For example, by selecting the output answer of sub-expression “5” as the final solution 340, additional sub-expressions such as sub-expression “6” can still assign a score to the problem that extends beyond the final solution (i.e., extra credit). Once the rubric is completed, interface 300 may include a button 342 to save and store the question.

As noted above, the rubric development interface 300, in some embodiments, is configured to accept one or more answer solution approaches. In the example implementation shown in FIG. 3B, interface 300 include a solution approach selection input 344 that allows the test developers to assign separate credit/score for specific solution approaches. FIG. 3C shows an expanded view of the solution approach selection input 344 (shown as 344a). FIG. 3D shows a second solution approach for the same word problem of FIG. 3B but having a different set of sub-expressions 316. The final solutions between the solution approach in FIG. 3B and FIG. 3D are the same.

Indeed, the rubric answer for a given solution approach is completely independent of other solution strategies. The grading algorithm can be configured to compute the credit/scores for each of the rubrics of each solution approach when performing the grading operation and then select or return the highest score/credit value among the evaluated solutions to be used as the score/credit value for that word problem. In some embodiments, interface 300 may allow a test developer to include conditional questions that may be only active when a given approach solution has been taken.

FIG. 3E shows an example dialogue box 346 to configure a given sub-expression, e.g., when the “edit” button 318 is selected. In this example, the dialogue box 346 includes a description field 348 of the associated sub-expression 316 and an assignable credit/score 350 for the sub-expression within the grading rubric.

FIG. 3F shows an example dialogue configuration box 352 to configure the workspace for a given problem type 354. In the example shown in FIG. 3F, problem types 354 include subject areas such as math, chemistry, biology, engineering, physics, and business. The presented list is non-exhaustive and can include other subjects described herein, among others. The dialogue box 352, in this example, also includes a grade-level field 356, which is also provided only as an example and is non-exhaustive. The dialogue configuration box 352 can be initiated, in this example, via metadata editor button 358. In some embodiments, the dialogue configuration box can be implemented as a wizard that allows the test developer to walk through a series of dialogue boxes to select the desired test type and/or grade/difficulty level. The dialogue boxes, in either embodiment, may include instructions or information associated with the provided workspace and initial/defaulted test configurations.

Based on the selection of the problem types 354 and/or grade level field 356, interface 300 may retrieve and instantiate a workspace having the appropriate operator workspace(s) (e.g., 307). For example, for a chemistry problem type, interface 300 may include a Periodic table, a standard reduction potential table, and a set of Chemistry constant tables. Different constant and reduction potential tables may be retrieved based on the selected grade level field 356.

FIG. 3G shows an example open-ended unstructured-text question for a chemistry-based question and corresponding answer model that may be implemented in the example computerized test system 100. The question may include symbols, e.g., periodic table or table elements that are embedded into the question. The system may provide an input that toggles the display of table 248. The table (e.g., 248) and other data objects may be presented as a new window or dialogue box. FIG. 3G also shows input for the interface to set the significant digit or decimal rounding for the provided answer.

FIG. 3H shows an example periodic table, a standard reduction potential table, and a set of Chemistry constant tables, reproduced from the AP exam and produced by the CollegeBoard, that may be provided, as a non-exhaustive example, in the operator and resource workspace 308 by the computerized test system 100. When implemented in the example computerized test system 100 described herein, each of the displayed elements of the periodic table, the reduction table, and the constant tables may have pre-defined operands that can be selectable for the word problem solution (e.g., in the answer rubric and the test).

Example Method of Operation

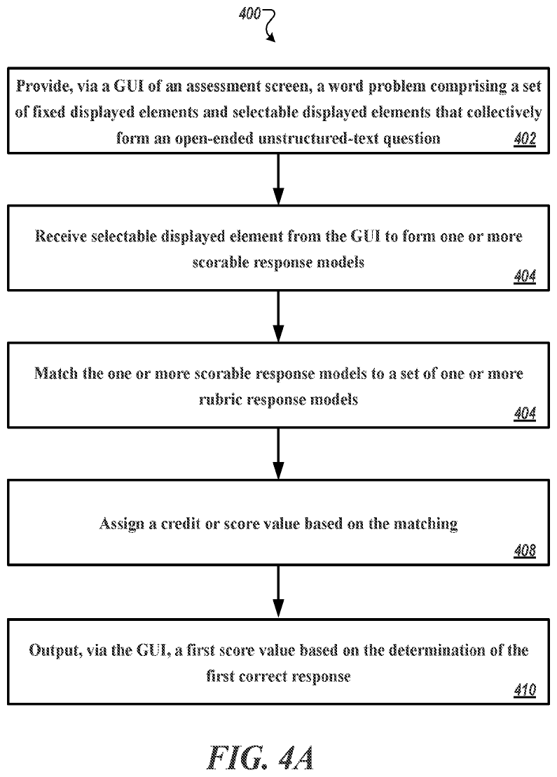

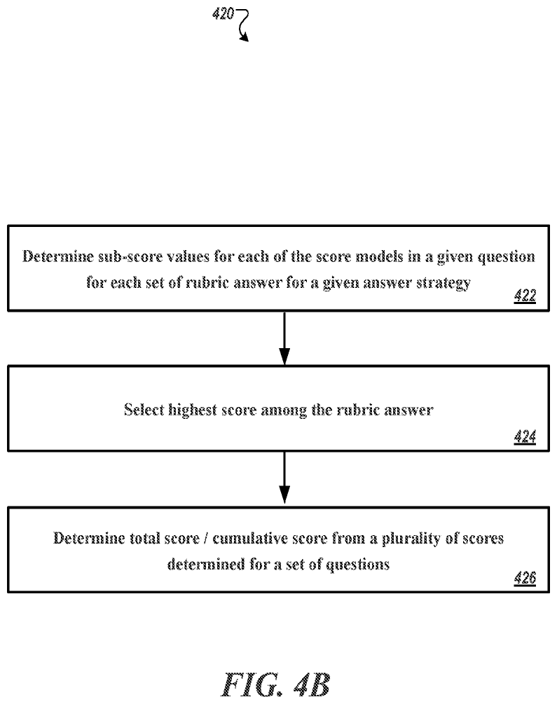

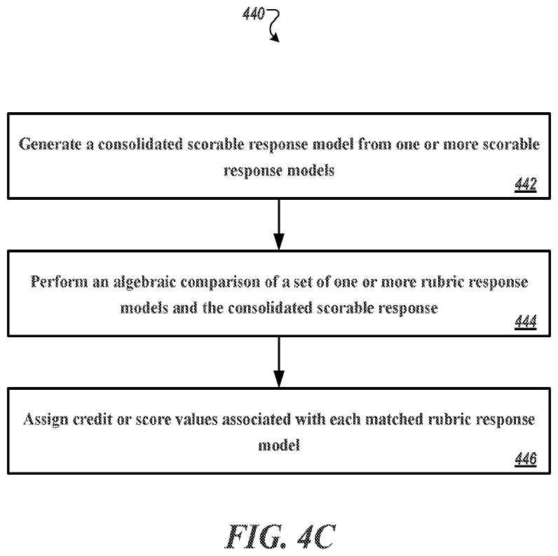

Method of Computerized Word Problem Testing and Scoring. FIG. 4A shows an example method 400 of operation of the computerized test system 100 to administer a word problem comprising an open-ended unstructured-text question, e.g., as described in relation to FIG. 2A, in accordance with an illustrative embodiment. Method 400 includes providing (402), by a processor, via a graphical user interface (GUI) (e.g. see FIG. 2A), in an assessment screen of the GUI, a word problem (e.g., 106) comprising (i) a set of fixed displayed elements having at least one of text, symbol, and equations and (ii) a set of selectable displayed elements having at least one of text, symbol, and equations interspersed within the set of fixed displayed elements. The set of selectable displayed elements may be selectable, via a drag-and-drop operation or selection operation, from the assessment screen, to construct one or more scorable response models or sub-expression (e.g., 208), and wherein each of the one or more scorable response models or sub-expression is assignable a score (e.g., 308) for the open-ended unstructured-text question.

Method 400 further includes placing (404), by the processor, the selectable displayed element in one or more scorable response models in response to receiving via the GUI a set of inputs from the assessment screen, wherein each of the set of inputs includes a selectable displayed element from the set of selectable displayed elements.

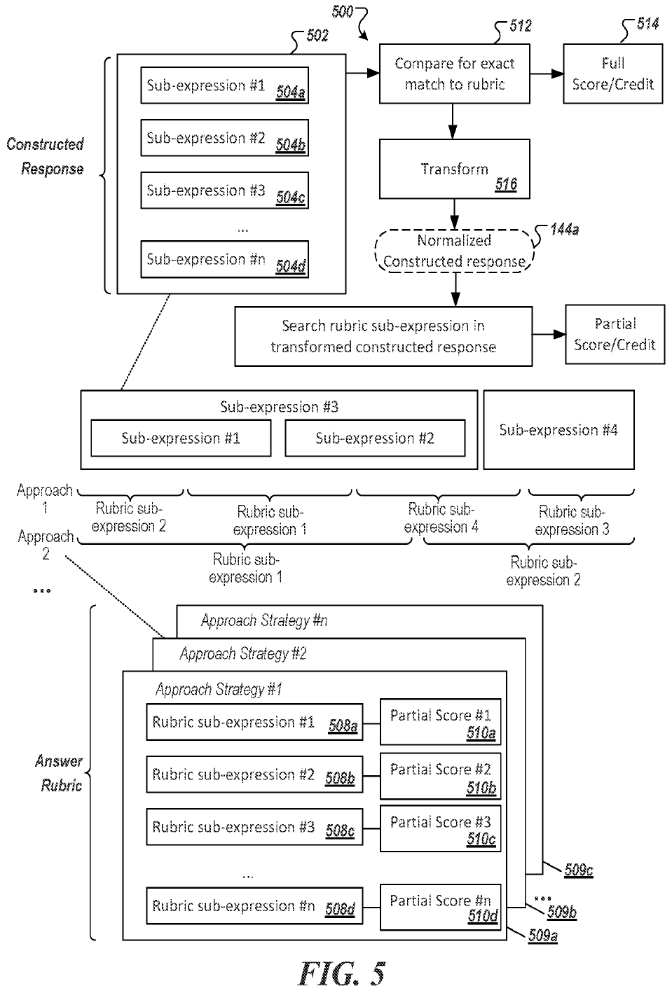

Method 400 further includes matching (406), by the processor, the one or more scorable response models to a set of one or more rubric response models, wherein each of the one or more rubric response models has an associated credit or score value. FIG. 5, later discussed, shows an example operation 500 performed by the grading pipeline and algorithm (e.g., 114) of FIG. 1 in accordance with an illustrative embodiment. Prior to or as part of the matching operation, the one or more scorable response models may be consolidated into a single consolidated scorable response to which the one or more rubric response models may be searched.

Method 400 further includes assigning (408), by the processor, a credit or score value associated with the one or more scorable response models based on the matching.

Method 400 further includes outputting (410), via the processor, via the graphical user interface, report, or database, the credit or score value for the word problem.

Method of Computerized Scoring for Multiple Answer Strategies. FIG. 4B shows a method 440 of operation for the computerized test system 100, e.g., of FIG. 1, to grade scores for an exam having word problems, each comprising an open-ended unstructured-text question and having multiple answer solutions.

Method 400 includes determining (422) sub-score values for each of the score models in a given question for each given answer strategy. The operation may include assessing the partial score/credit values for each of the rubric response models for each of multiple available answer strategies for a given problem.

Method 400 then includes determining and selecting (424) a highest score among the rubric answers.

Method 400 then includes determining (426) a total score for the given question by summing the individual scores for each word problem (as well as non-word problems, if applicable).

Method of Computerized Scoring using Algebraic Comparison. FIG. 4C shows a method 440 to score a word problem comprising an open-ended unstructured-text question using an algebraic comparison operation. Method 442 includes generating (442) a consolidated scorable response model from one or more scorable response models. Method 40\40 includes performing an algebraic comparison of a set of one or more rubric response models and the consolidated scorable response. Example pseudocode for operations 442, 442 are described relation in relation to Table 3D.

Method 440 then includes determining the score/credit values associated with each matched rubric response model per the algebraic comparison

Example Grading Algorithm

The grading algorithm implements an assessment methodology for the mathematical constructed-response problems (also known as “word problems”) that can achieve automated (i.e., computerized) partial credit scoring comparable to that of an expert human grader using a scoring rubric, e.g., generated through the test development environment of FIG. 1. The grading algorithm, in some embodiments, is configured to receive constructed response from a computerized exam as provided from the testing workflow module 126 of a test environment platform 102 of FIG. 1. In other embodiments, the grading algorithm can be used to score/grade a test response generated from an OCR image of a word problem exam.

The grading algorithm is configured, in some embodiments, to perform a deep search of the student's constructed response and mathematically compare each element of the rubric with sub-expressions of the constructed response. When a match is found for a particular rubric element, the specified partial credit (or full credit if applicable) for that element is added to the student's score for the problem. With this approach, the student's response is scored and partial score or credit is assigned to the problem even when multiple rubrics may exist for that problem. The grading algorithm can be configured to combine the student's response into a single constructed response while properly handling mathematical properties such as associativity and commutativity properties of the answer. Notably, the action of combining the submitted sub-expression into a single expression to be searched for components that have an attributed partial score, via an algebraic comparison, can remove the artificial constraints generated by the formatting of the answer in the constructed response. Order of sequence associated with the associativity and commutativity properties of the answer is accounted for in the scoring and does not require the test developer to consider such properties when generating the rubric for the question. In addition, different partitioning of the constructed response over multiple lines does not require the test developer to consider such formatting in the answer when generating the rubric for the question.

The grading algorithm can provide partial grading based on different solution approaches that may exist for a given mathematical problem based on algebraic comparison of rubric provided answer and is thus not limited to a single answer or answer format for a given problem. For example, a geometry problem may require the test taker/student to determine multiple lengths and/or angles in a given geometry which can be first evaluated by angles or through geometric transforms. To account for and provide credit for the different solution approaches, the grading algorithm can first consolidate sub-expression of a given constructed response into a single expression that can then be searched, via an algebraic comparison, according to one or more rubrics, each having score values or credits assigned for a given rubric sub-expression. The test development environment platform 104 is configured to receive multiple solution strategies for a given problem, when applicable, in which each strategy solution has its own rubric and associated score. The grading algorithm can evaluate each constructed response for each of the available rubrics and can assign the highest score achieved across all evaluated rubrics as the score for the constructed response.

In some embodiments, the grading algorithm is configured to perform the deep search for the partial credit assessment when the final answer submitted by the student is not mathematically equivalent to the answer provided by the rubric (or rubrics). Indeed, unlike other automated scoring systems, the correctness of the final answer is based on an algebraic comparison, not a numerical comparison, so the maximum scoring is not assigned to the test taker/student through the guessing of a final correct answer.

It should be further noted that while the grading algorithm is well suited for the assessment of a student's constructed response, it is also well suited to serve as an instructional tool. For example, the deep search process can identify missing or incorrect steps in the submitted solution and provide relevant hints and/or feedback to the student. Aggregate data from the grading algorithm can also serve to inform instructors on which solution steps are giving students the most difficulty, thus providing feedback that can be used to improve teaching.

FIG. 5 shows an example operation 500 performed by the grading pipeline and algorithm 114 of FIG. 1 in accordance with an illustrative embodiment. In the example shown in FIG. 5, a constructed response 502 (e.g., previously referred to as response model 138 in FIG. 1) is provided comprising a set of sub-expressions 504 (shown as 504a, 504b, 504c, 504d) (the sub-expressions were previously referred to or is a part of the response model 208 in FIG. 2A). Operation 500 will evaluate the constructed response 502 to the answer rubric 506 (e.g., previously referred to as rubric model 140 in FIG. 1). The answer rubric 506 for each strategy of multiple potential strategies 509 (shown as 509a, 509b, 509c) includes a plurality of rubric sub-expressions 508 (shown as 508a, 508b, 508c, 508d) (previously referred to as 316) each having an associated score/credit value 510 (shown as 510a, 510b, 510c, 510d) (previously referred to as 318).

Operation 500, in some embodiments, includes first comparing (512) the submitted sub-expressions 504 to the answer rubric 508. If an exact match is found, the full score/credit value is assigned (514) for the problem. When the exact match is not found, operation 500 then includes transforming (516), e.g., via module 142, the submitted sub-expressions 504 into a single consolidated expression 144 (shown as 144a). Operation 500 then can perform a search, via an algebraic comparison, of the single consolidated expression 144a for individual rubric sub-expressions 508 associated with each of the approach strategies. In some embodiments, a solver (e.g., 146 of FIG. 1) is employed that can determine algebraic equivalence and parse for algebraic expressions and simplified versions thereof. Each identified rubric sub-expression can be assigned the associated partial score/credit (e.g., 510), and the total score for each approach strategy can be calculated. The highest score among the evaluated approach strategies can be assigned as the score for the problem.

Tables 1, 2, and 3 provide example pseudocode for the data structure of the grading rubric and constructed response as well as the algorithm/functions of the grading algorithm.

Specifically, Table 1 shows an example data structure of the grading rubric for the grading algorithm. Table 2 shows an example data structure for a constructed response. Tables 3A-3I show example grading algorithm and its sub-functions. The grading algorithms of Tables 3A-3I takes three data structures as inputs: stepList (Table 2), rubricList (Table 1), and answerList (not shown).

The rubricList (Table 1) includes the data structure of the grading rubric for a given approach solution. The stepList (Table 2) is the student's constructed response to the problem. The answerList (not shown) is a one-to-one mapping of step indices in stepList to answers within the rubricList. To complete the solution to submit to the grading algorithm, the student may drag and/or select a set of operands to provide a sub-expression as the constructed response to each answer box provided for the problem. In some embodiment, this information may be passed to the grading algorithm by appending it to each answers item within rubricList, rather than creating a separate answersList structure

TABLE 1

| | |
|---|---|
| 1 | rubricList: |
| 2 | 0: |
| 3 | steps: |
| 4 | 0: |
| 5 | expr: algebraic expression |
| 6 | desc: description of this solution step |
| 7 | points: partial credit points for this solution step |
| 8 | prereq: list of prerequisite steps, if applicable |
| 9 | strict: boolean True or False (see explanation below) |
| 10 | 1−n: additional steps, as above |
| 11 | answers: |
| 12 | 0: |
| 13 | label: answer label, e.g., “Distance traveled” * |
| 14 | post: optional answer postfix, typically to specify units, e.g., |
| 15 | “miles” * |
| 16 | answer_index: index of correct answer in steps |
| 17 | sigfigs: optional * |
| 18 | value: correct number of significant figures for this answer |
| 19 | points: points added for correct significant figures |
| 20 | 1−n: additional answers, if required |
| 21 | 1−n: additional rubrics as needed for multiple solution strategies |
| 22 | * - elements label, post, and sigfigs are common across all rubrics |

As shown in Table 1, multiple rubricList may be generated per Table 1, lines 2 and 21 in which each rubricList corresponds to each strategy approach. Within each rubricList, multiple “steps” can be defined per Table 1, lines 4 and 10 in which each step includes a sub-expression (line 5), a description (line 6), an associated credit/score value (line 7), a list of prerequisite steps (line 8), and a strict parameter (line 9).

The strict parameter indicates whether a closed or an open match is employed in the partial credit determination, e.g., in additive and multiplicative expressions in the deep search of the constructed response. For example, suppose the sub-expression a+c is indicated to be a rubric sub-expression for partial credit in a given problem—that is, partial credit is to be assigned if the sub-expression a+c is found within the student's constructed response. If the strict parameter is set to “False,” partial credit will be awarded for an open match; for example, if the constructed response contains the subexpression a+b+c since it includes a+c as well as other commutative and associative properties that are available for a given solver. And, if the strict parameter is set to “True,” the partial credit will be awarded only in a closed-match—that is, if a+c or c+a is found as a subexpression within the constructed response.

Also, as shown in Table 1, each rubricList may include multiple final solutions for a given problem per lines 11, 12, and 20. Within each solution, the solution may include an answer label (line 13), an optional postfix such as for units (lines 14, 15), an answer index corresponding to the step number having the final solution (line 16), and an optional significant figure parameter (line 17). The significant figure parameter may include sub-parameters for the number of the significant digits (line 18) and associated score/credit value (line 19) for a correct significant digits being used.

Table 2 shows an example data structure for a constructed response.

TABLE 2

| | |
|---|---|
| 1 | stepList: |
| 2 | 0: |
| 3 | expr: algebraic expression |
| 4 | prereq: list of prerequisite steps, if applicable |
| 5 | 1−n: additional steps, as needed |

As shown in Table 2, the constructed response includes multiple stepList per Table 2, lines 2 and 5 in which each stepList corresponds to each sub-expression or sub-model provided in the constructed answer. Within each stepList, a step includes a sub-expression (line 3) and a list of prerequisite steps if applicable (line 4).

Example Pseudocode. The grading algorithm written in python-like pseudocode is provided below. Certain functions written in the pseudocode below rely on the use of a Computer Algebra System (CAS) such as SymPy (https://www.sympy.org/en/index.html). Specifically, in some embodiments, the CAS can be used for symbolic processing functions, including (i) determination of algebraic equivalence; (ii) parsing of algebraic expressions; and (iii) simplification and evaluation of algebraic expressions. The code to award points for correct significant figures is not shown for simplicity, though it could be readily employed.

Table 3A shows an example main function of the grading algorithm.

TABLE 3A

| Line | Pseudocode |
|---|---|
| 1 | def doGrader (rubricList, stepList, answerList): |
| 2 | for r in rubricList: |
| 3 | let r[‘score’] = 0 |
| 4 | let steps = r[‘steps'] |
| 5 | for s in steps: |
| 6 | # mark all steps “not checked” initially |
| 7 | let s[‘checked’] = False |
| 8 | for a in r[‘answers'], b in answerList: |
| 9 | let rubric_answer_index = a[‘answer_index’] |
| 10 | let student_answer_index = b[‘stepId’] |
| 11 | let correct_answer = steps[rubric_answer_index][‘expr’] |
| 12 | let student_answer = stepList[student_answer_index][‘expr’] |
| 13 | if student_answer is algebraically equivalent to correct_answer: |
| 14 | award full credit, checking sigfigs if applicable |
| 15 | done |
| 16 | else: |
| 17 | let r[‘score’] += assessPartial (rubric_answer_index, steps) |
| 18 | award max(r[‘score’] for r in rubricList), checking sigfigs if applicable |

In Table 3A, the main loop is called by the doGrader function, which can take in instantiated instances of the rubricList, stepList, and answerList data object/structures as discussed in relation to Tables 1 and 2. As shown in Table 3A, for the multiple rubricList per line 2, the algorithm calculates the score for each of the rubricList per lines 3-17 and assigns the maximum score among the evaluated rubricList per line 18. For each rubricList, the algorithm initializes the score value (line 3), initializes the counter tracking the evaluated steps (lines 4-7). The algorithm first evaluates per lines 9-15 if the provided sub-expression is algebraically equivalent to the rubric sub-expression per line 13 and assigns the full score if it does per lines 14-15. If the sub-expression is not algebraically equivalent to the rubric sub-expression per line 13, then the algorithm performs the assessPartial function for each of the rubric sub-expression (rubric_answer_index) and provided sub-expression (steps).

Table 3B defines an assess partial credit function, assessPartial. It receives an index and steps from Table 3A.

TABLE 3B

| Line | Pseudocode |
|---|---|
| 1 | def assessPartial (index, steps): |
| 2 | let c = steps[index] |
| 3 | let points = 0 |
| 4 | if ‘prereq’ in c: |
| 5 | for prereq in c[‘prereq’]: |
| 6 | let p = steps[prereq] |
| 7 | if not p[‘checked’]: |
| 8 | if ‘strict’ in p: |
| 9 | strict = p[‘strict’] |
| 10 | else: |
| 11 | strict = False |
| 12 | let expr = p[‘expr’] |
| 13 | if checkSubExpr(stepList, expr, strict): |
| 14 | points += computeCredit(prereq, steps) |
| 15 | else: |
| 16 | points += assessPartial(prereq, steps) |
| 17 | return points |

In Table 21B, the assessPartial function performs evaluations for pre-requisite and strict parameters per lines 2-11. The main operator in the assessPartial function is the checkSubExpr function which is described in Table 3C. Table 3C defines a compute credit function, computeCredit. It computes the total partial credit points found by the deep seaerch of the submitted solution. It receives an index corresponding to the pre-requisite index and steps to recursively step through the steps array and compute total points at the prerequisite steps. The function also marks them as credited so that they are not counted redundantly in the case of multi-answer questions.

TABLE 3C

| Line | Pseudocode |
|---|---|
| 1 | def computeCredit(index, steps): |
| 2 | let c = steps[index] |
| 3 | if c[‘checked’]: |
| 4 | return 0 # already credited |
| 5 | if ‘points' in c: |
| 6 | let points = c[‘points'] |
| 7 | c[‘checked’] = True |
| 8 | if ‘prereq’ in c: |
| 9 | for prereq in c[‘prereq’] |
| 10 | points += computeCredit(prereq, steps) |
| 11 | return points |

Table 3D defines a check sub-expression function, checkSubExpr. It receives the student's constructed-response object, stepList, the expression, expr, and the object, strict, as its input and builds a product or sum lists depending on the root node of the sub-expression. To handle the associative and commutative properties of addition and multiplication, the function converts each node of the expression tree into either a list of sum or product terms, depending on the root node. For example, the expression a+b−c*d is converted to a sum list of the form [a, b, −c*d] for subsequent searching. A simple search for elements in the list can effectively determine a match, taking associativity and commutativity into proper account.

TABLE 3D

| Line | Pseudocode |
|---|---|
| 1 | def checkSubExpr (stepList, expr, strict): |
| 2 | if the root of subExpr is a multiplicative node: |
| 3 | subList = mkProductList(subExpr) |
| 4 | exprList = findProductNodes(stepList) |
| 5 | for i in range(len(exprList)): |
| 6 | exprList[i] = mkProductList(exprList[i]) |
| 7 | else: |
| 8 | subList = mkSumList(subExpr) |
| 9 | exprList = findSumNodes(stepList) |
| 10 | for i in range(len(exprList)): |
| 11 | exprList[i] = mkSumList(exprList[i]) |
| 12 | |
| 13 | # Look for an element of exprList which contains all terms in |
| 14 | # subList. If all terms are found in exprList[i]: |
| 15 | # if strict is False: |
| 16 | # return True |
| 17 | # else if the lengths of subList and exprList[i] are the same: |
| 18 | # return True |
| 19 | # else continue to the next element of exprList |
| 20 | # |
| 21 | # Return False if no elements of ExprList match subList |
| 22 | |
| 23 | for i in range(len(exprList)): |
| 24 | found = True |
| 25 | for j in range(len(subList)): |
| 26 | match = False |
| 27 | for k in range(len(exprList[i])): |
| 28 | if sublist[j] is algebraically equivalent to exprList[i][k]: |
| 29 | match = True # subList[j] matches a term in exprList[i] |
| 30 | break |
| 31 | if match == False: |
| 32 | found = False |
| 33 | break |
| 34 | if found: |
| 35 | # all terms matched in exprList[i] |
| 36 | if strict: |
| 37 | # all elements must match |
| 38 | if len(exprList[i]) == len(subList): |
| 39 | return True |
| 40 | else: |
| 41 | return True |
| 42 | return False |

Table 3E defines a find sub-expression function, findSubExpressions. It receives a data object, node, as its input and recursively builds a list of all sub-expressions which are descendants of a given expression node.

TABLE 3E

| Line | Pseudocode |
|---|---|
| 1 | def findSubExpressions(node): |
| 2 | let exprList = [ ] # empty list |
| 3 | |
| 4 | def findSubExpr(node): |
| 5 | if len(list of terms in node) > 0: |
| 6 | exprList.append(node) |
| 7 | for arg in the list of terms in node: |
| 8 | findSubExpr(arg) |
| 9 | |
| 10 | findSubExpr(node) |
| 11 | return exprList |

Table 3F defines a find sum nodes function, findSumNodes. It receives a student's constructed response object, stepList, as its input and recursively builds a list of all additive sub-expressions, which are descendants of expressions within stepList.

TABLE 3F

| Line | Pseudocode |
|---|---|
| 1 | def findSumNodes(stepList): |
| 2 | let sumList = [ ] |
| 3 | |
| 4 | def findAdd(node): |
| 5 | if (this is an additive node): |
| 6 | sumList.append(node) |
| 7 | for arg in the list of additive terms in node: |
| 8 | findAdd(arg) |
| 9 | |
| 10 | for step in stepList: |
| 11 | findAdd(step[‘expr’]) |
| 12 | sumList.append(step[‘expr’]) |
| 13 | return sumList |

Table 3G defines a find product nodes function, findProductNodes. It receives a student's constructed response object, stepList, as its input and recursively builds a list of all multiplicative sub-expressions which are descendants of expressions within stepList.

TABLE 3G

| Line | Pseudocode |
|---|---|
| 1 | def findProductNodes(stepList): |
| 2 | let productList = [ ] # empty list |
| 3 | |
| 4 | def findMul(node): |
| 5 | if (this is a multiplicative node): |
| 6 | productList.append(node) |
| 7 | for arg in the list of multiplicative terms in node: |
| 8 | findMul(arg) |
| 9 | |
| 10 | for step in stepList: |
| 11 | findMul(step[‘expr’]) |
| 12 | productList.append(step[‘expr’]) |
| 13 | return productList |

Tables 3H and 3I are an important aspect of the grading algoritm in providing the conversion of an additive or multiplicative expression into a list of sum or product terms that is lendable to being searched. For example, mkSumList (Table 3H) can take an expression like a+b+c*d and convert it to a list of sum terms: [a, b, c*d]. The algoritm can then search the list for any combination of terms, which allows the grading algorithm to efficiently handle the associative and commutative properties of addition. Table 3I shows the same in handing the associative and commutative properties of multiplication.

Table 3H defines a make sum list function, mkSumList. It receives an input, expr, and converts the expression of the form (e₁+e₂+ . . . +e_{N}) to a list of the form [e₁, e₂, . . . , e_{N}]. As noted, the conversion of an additive expression to a searchable list of sum terms provides for efficient processing of the commutative and associative properties of addition.

TABLE 3H

| Line | Pseudocode |
|---|---|
| 1 | def mkSumList(expr): |
| 2 | if expr is an additive expression: |
| 3 | let sumList = list(additive terms e1 through eN) |
| 4 | else: |
| 5 | let sumList = list(expr) # single term list |
| 6 | return sumList |

Table 3I defines a make product list function, mkProductList. It receives an input, expr, and converts the expression of the form (e₁*e₂* . . . *e_{N}) to a list of the form [e₁, e₂, . . . , e_{N}]. As noted, the conversion of a multiplicative expression to a searchable list of product terms provides for efficient processing of the commutative and associative properties of multiplication.

TABLE 3I

| Line | Pseudocode |
|---|---|
| 1 | def mkProductList(expr): |
| 2 | if expr is an additive expression == Mul: |
| 3 | let productList = list(multiplicative terms e1 through eN) |
| 4 | else: |
| 5 | let productList = list(expr) # single term list |
| 6 | return productList |

### Discussion and Examples

A study was conducted to develop an automated quantitative constructed-response problem (QCRP) grader, as discussed herein. In the study, test takers were asked to solve problems at a computer workstation. An important aspect of the grader is that the user clicks and drags-and-drops or copy-pastes values from the problem statement or additional tables onto a blank problem-solving space. This design feature allows every value to have a known origin so that it becomes feasible to grade the response automatically.

While some educational software allows the user to click and drag, tests taken at computers tend to involve either essay writing or multiple-choice items. This is the case of the computer-adaptive Graduate Record Examination, for instance. Developing the exemplary grader would allow test publishers to enrich their existing computer-delivered tests by adding QCRPs, potentially increasing validity and fairness. It could also allow tests, including QCRPs, which are conventionally graded manually to be automated for greater speed and accuracy of evaluation, as well as reduce cost.

Exemplary Computing Device

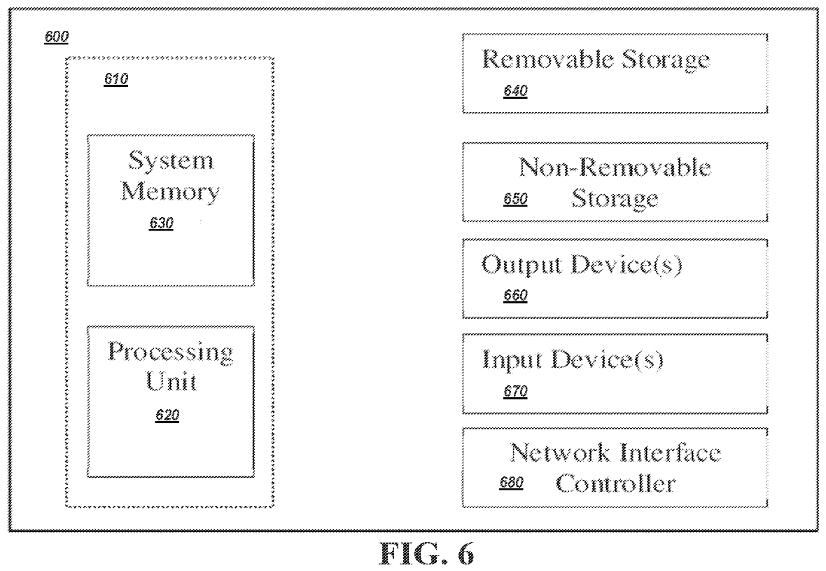

Referring to FIG. 6, an example computing device 600 upon which embodiments of the exemplary grading system may be implemented is illustrated. It should be understood that the example computing device 600 is only one example of a suitable computing environment upon which embodiments of the invention may be implemented. Optionally, the computing device 600 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In an embodiment, the computing device 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device 600 to provide the functionality of a number of servers that is not directly bound to the number of computers in the computing device 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or maybe hired on an as-needed basis from a third-party provider. Some cloud computing environments may comprise cloud computing resources owned and operated by the enterprise as well as cloud computing resources hired and/or leased from a third-party provider.

In its most basic configuration, computing device 600 typically includes at least one processing unit 620 and system memory 630. Depending on the exact configuration and type of computing device, system memory 630 may be volatile (such as random-access memory (RAM)), non-volatile (such as read-only memory (ROM), flash memory, etc.), or some combination of the two. This most basic configuration is illustrated in FIG. 6 by dashed line 610. The processing unit 620 may be a standard programmable processor that performs arithmetic and logic operations necessary for the operation of the computing device 600. While only one processing unit 620 is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device 600 may also include a bus or other communication mechanism for communicating information among various components of the computing device 600.

Computing device 600 may have additional features/functionality. For example, computing device 600 may include additional storage such as removable storage 640 and non-removable storage 650, including, but not limited to, magnetic or optical disks or tapes. Computing device 600 may also contain network connection(s) 680 that allow the device to communicate with other devices such as over the communication pathways described herein. The network connection(s) 680 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 600 may also have input device(s) 670 such as keyboards, keypads, switches, dials, mice, trackballs, touch screens, voice recognizers, card readers, paper tape readers, or other well-known input devices. Output device(s) 660 such as printers, video monitors, liquid crystal displays (LCDs), touch screen displays, displays, speakers, etc. may also be included. The additional devices may be connected to the bus in order to facilitate the communication of data among the components of the computing device 600. All these devices are well known in the art and need not be discussed at length here.

The processing unit 620 may be configured to execute program code encoded in tangible, computer-readable media. Tangible, computer-readable media refers to any media that is capable of providing data that causes the computing device 600 (i.e., a machine) to operate in a particular fashion. Various computer-readable media may be utilized to provide instructions to the processing unit 620 for execution. Example tangible, computer-readable media may include but is not limited to volatile media, non-volatile media, removable media, and non-removable media implemented in any method or technology for storage of information such as computer-readable instructions, data structures, program modules, or other data. System memory 630, removable storage 640, and non-removable storage 650 are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain.

In an example implementation, the processing unit 620 may execute program code stored in the system memory 630. For example, the bus may carry data to the system memory 630, from which the processing unit 620 receives and executes instructions. The data received by the system memory 630 may optionally be stored on the removable storage 640 or the non-removable storage 650 before or after execution by the processing unit 620.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

Embodiments of the methods and systems may be described herein with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps or combinations of special purpose hardware and computer instructions.

Use of the phrase “and/or” indicates that anyone or any combination of a list of options can be used. For example, “A, B, and/or C” means “A,” or “B,” or “C,” or “A and B,” or “A and C,” or “B and C,” or “A and B and C.” As used in the specification, the singular forms “a,” “an” and “the” include plural referents unless the context clearly dictates otherwise. Moreover, titles or subtitles may be used in this specification for the convenience of a reader, which shall have no influence on the scope of the disclosed technology. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology should be interpreted for the sake of clarity. It is intended that each term contemplates its broadest meaning as understood by those skilled in the art and includes all technical equivalents that operate in a similar manner to accomplish a similar purpose.

It is to be understood that the mention of one or more steps of a method does not preclude the presence of additional method steps or intervening method steps between those steps expressly identified. Steps of a method may be performed in a different order than those described herein. Similarly, it is also to be understood that the mention of one or more components in a device or system does not preclude the presence of additional components or intervening components between those components expressly identified.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Moreover, it should be appreciated that any of the components or modules referred to with regards to any of the present invention embodiments discussed herein may be integrally or separately formed with one another. Further, redundant functions or structures of the components or modules may be implemented. Moreover, the various components may be communicated locally and/or remotely with any user or machine/system/computer/processor. Moreover, the various components may be in communication via wireless and/or hardwire or other desirable and available communication means, systems, and hardware. Moreover, various components and modules may be substituted with other modules or components that provide similar functions.

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings.

The present disclosure is capable of other embodiments and of being practiced or carried out in various ways. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the disclosure, including all modifications and equivalents.

1. A computer-implemented method comprising:
providing, by a processor, via a graphical user interface (GUI), in an assessment screen of the GUI, a word problem as an open-ended unstructured-text question comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question;
in response to receiving via the GUI a set of inputs from the assessment screen, wherein each of the set of inputs includes a selectable displayed element from the set of selectable displayed elements, placing, by the processor, the selectable displayed element in one or more scorable response models;
matching, by the processor, the one or more scorable response models to a set of one or more rubric response models, wherein each of the one or more rubric response models has an associated credit or score value;
assigning, by the processor, a credit or score value associated with the one or more scorable response models based on the matching; and
outputting, via the processor, via the graphical user interface, report, or database, the credit or score value for the word problem.

2. The method of claim 1, further comprising:
generating, by the processor, a consolidated scorable response model from the one or more scorable response models;
performing an algebraic comparison of the set of one or more rubric response models and the consolidated scorable response models to identify a presence of at least one of the set of one or more rubric response models; and
assigning, by the processor, a partial credit or score value associated with the at least one of the set of one or more rubric response models.

3. The method of claim 2, further comprising:
determining, by the processor, a total partial credit or score value for the word problem by summing each matching set of one or more rubric response models to the consolidated scorable response model.

4. The method of claim 1, further comprising:
matching, by the processor, the one or more scorable response models to a second set of one or more rubric response models, wherein each of the second set of one or more rubric response models has an associated credit or score value, and wherein at least one of the rubric response models of the second set of one or more rubric response models is different from the set of one or more rubric response models.

5. The method of claim 4, further comprising:
determining a highest aggregated score among the set of one or more rubric response models and the second set of one or more rubric response models, wherein the highest aggregated score is assigned as the score for the word problem.

6. The method of claim 2, wherein the algebraic comparison is performed by a solver configured to perform symbolic manipulations on algebraic objects.

7. The method of claim 1, further comprising:
receiving input from a second assessment screen, wherein the second assessment screen comprises a plurality of constant values organized and arranged as at least one of a constant table and a Periodic table.

8. The method of claim 1, wherein the GUI includes a plurality of input fields to receive the one or more scorable response models, wherein each input field is configured to receive a scorable response model of the one or more scorable response models to provide a constructed response for the word problem.

9. The method of claim 1, wherein the word problem has an associated subject matter of at least one of a math problem, a chemistry problem, a physics problem, a business school problem, a science, technology, and math (STEM) problem, and an engineering problem.

10. The method of claim 1, wherein the one or more rubric response models and the associated credit or score values are generated in a test development workspace.

11. The method of claim 10, wherein the test development workspace includes a plurality of input rubric fields to receive the one or more rubric response models and the associated credit or score values.

12. (canceled)

13. A system comprising:
a processor; and
a memory having instructions stored thereon, wherein execution of the instructions by the processor causes the processor to:
provide, via a graphical user interface (GUI), in an assessment screen of the GUI, a word problem as an open-ended unstructured-text question comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question;
in response to receiving via the GUI a set of inputs from the assessment screen, wherein each of the set of inputs includes a selectable displayed element from the set of selectable displayed elements, place the selectable displayed element in one or more scorable response models;
match the one or more scorable response models to a set of one or more rubric response models, wherein each of the one or more rubric response models has an associated credit or score value;
assign a credit or score value associated with the one or more scorable response models based on the matching; and
output via the graphical user interface, report, or database, the credit or score value for the word problem.

14. The system of claim 13, wherein the execution of the instructions by the processor further causes the processor to:
generate a consolidated scorable response model from the one or more scorable response models;
perform an algebraic comparison of the set of one or more rubric response models and the consolidated scorable response models to identify a presence of at least one of the set of one or more rubric response models; and
assign a partial credit or score value associated with the at least one of the set of one or more rubric response models.

15. The system of claim 14, wherein the execution of the instructions by the processor further causes the processor to:
determine a total partial credit or score value for the word problem by summing each matching set of one or more rubric response models to the consolidated scorable response model.

16. The system of claim 13, wherein the execution of the instructions by the processor further causes the processor to:
match the one or more scorable response models to a second set of one or more rubric response models, wherein each of the second set of one or more rubric response models has an associated credit or score value, and wherein at least one of the rubric response models of the second set of one or more rubric response models is different from the set of one or more rubric response models.

17. The system of claim 16, wherein the execution of the instructions by the processor further causes the processor to:
determine a highest aggregated score among the set of one or more rubric response models and the second set of one or more rubric response models, wherein the highest aggregated score is assigned as the score for the word problem.

18. The system of claim 14, wherein the algebraic comparison is performed by a solver configured to perform symbolic manipulations on algebraic objects.

19. The system of claim 13, wherein the execution of the instructions by the processor further causes the processor to:
receive input from a second assessment screen, wherein the second assessment screen comprises a plurality of constant values organized and arranged as at least one of a constant table and a Periodic table.

20.-23. (canceled)

24. A non-transitory computer-readable medium having instruction stored thereon wherein execution of the instructions by a processor causes the processor to:
provide, via a graphical user interface (GUI), in an assessment screen of the GUI, a word problem as an open-ended unstructured-text question comprising (i) a set of fixed displayed elements having at least one of text, symbol, and equations and (ii) a set of selectable displayed elements having at least one of text, symbol, and equations interspersed within the set of fixed displayed elements, wherein the set of selectable displayed elements are selectable, via a drag-and-drop operation or selection operation, from the assessment screen, to construct one or more scorable response models or sub-expression, and wherein each of the one or more scorable response models or sub-expression is assignable a score for the open-ended unstructured-text question;
in response to receiving via the GUI a set of inputs from the assessment screen, wherein each of the set of inputs includes a selectable displayed element from the set of selectable displayed elements, place the selectable displayed element in one or more scorable response models;
match the one or more scorable response models to a set of one or more rubric response models, wherein each of the one or more rubric response models has an associated credit or score value;
assign a credit or score value associated with the one or more scorable response models based on the matching; and
output via the graphical user interface, report, or database, the credit or score value for the word problem.

25.-34. (canceled)
